(19) United States
(12) Patent Application Publication
(10) Pub. No.: US 2010/0088339 A1
(43) Pub. Date: Apr. 8, 2010

(54) METHOD AND DEVICE FOR SELECTING AN IRRADIATION PLAN AND IRRADIATION FACILITY

(76) Inventors: EIKE RIETZEL, Darmstadt (DE); MARIE VIDAL, Villeurbanne (DE)

Correspondence Address: BRINKS HOFER GILSON & LIONE, P.O. BOX 10395, CHICAGO, IL, 60610, US

(21) Appl. No.: 12/545,621

(22) Filed: Aug. 21, 2009

(30) Foreign Application Priority Data
Aug. 29, 2008 (DE) 10 2008 044 901.6

(51) Int. Cl. G06F 7/10; G06F 17/30

(52) U.S. Cl. 707/780; 707/E17.014

(57) ABSTRACT

A method and device for selecting an irradiation plan, and irradiation facility is provided. The method may include, in a first phase, detecting a plurality of planning data records in which a target volume for irradiating and with varying position is represented in a target object, and creating an irradiation plan for each of these planning data records, and, in a second phase, which follows the first phase, recording a verification data record, comparing the verification data record with the plurality of planning data records with respect to similarity, selecting a planning data record from the plurality of planning data records which has the greatest similarity to the verification data record, selecting the irradiation plan which is associated with the selected planning data record, and to a device for carrying out the method and to an irradiation facility having such a device.

The present patent document claims the benefit of the filing date of DE 10 2008 044 901.6, filed Aug. 29, 2008, which is hereby incorporated by reference.

### BACKGROUND

The present embodiments relate to function monitoring in medical accelerator systems. More specifically, the present embodiments may relate to a method and to a device for selecting an irradiation plan, and to an irradiation facility having such a device.

Irradiation plans are determined in advance of radiotherapy. This determination is sometimes difficult as the internal anatomy of a patient can change over time. By way of example, target volumes inside the abdomen can change their position from day to day or over the course of several days or weeks. A typical organ that is often subject to a change in position is the prostate. Thus, for example, the bladder, situated next to the prostate, and the rectum, situated next to the prostate, can have an effect on the position and shape of the prostate, depending on the level of fullness of the bladder and/or rectum.

One possibility for taking account of these changes is the use of safety margins. In irradiation planning safety margins are selected such that an internal displacement/deformation of the target volume is taken into account. Although the adverse effects of a change in the position of the target volume may be moderated using these safety margins, the margins can lead to irradiation of adjacent, critical structures, such as the bladder or rectum, for example.

The dissertation by Nikoghosyan A., “Evaluation of the therapeutical potential of heavy ion therapy for patients with locally advanced prostate cancer”, October 2004, Medical Faculty Heidelberg, discloses the concept of determining a clinical target volume (CTV) from a gross tumor volume (GTV) by expanding by margins. A planning target volume (PTV) is determined herefrom with an additional safety margin in order, inter alia, to take into account an organ movement. The size of the target volume was re-evaluated using additional, successive CT data records.

The concept of calculating a plurality of irradiation plans with different safety margins for a target volume (MMODS: “multiple-margin optimization with daily selection”) is known from the document US 2005/0201516 A1. A user can then select the irradiation plan in real time from a large number of optimized irradiation plans in order to take account of an observed change in the size or position of the tumor or the structures surrounding it.

### SUMMARY AND DESCRIPTION

The present embodiments may obviate one or more of the drawbacks or limitations inherent in the related art. For example, in one embodiment, an irradiation plan is selected such that the irradiation plan takes good-quality account of a change in the position of the target volume for irradiating to be selected quickly and easily.

Developments and advantages, as are described in the following description in conjunction with one of the methods, apply analogously to one of the devices and vice versa.

In one embodiment, a method for selecting an irradiation plan is provided. The method includes, in a first phase, detecting a plurality of planning data records in which a target volume for irradiating and with varying position is represented in a target object, and creating an irradiation plan for each of these planning data records. In a second phase, which follows the first phase, the method may include recording a verification data record, comparing the verification data record with the plurality of planning data records with respect to similarity, selecting a planning data record from the plurality of planning data records which has the greatest similarity to the verification data record, and selecting the irradiation plan which is associated with the selected planning data record.

The planning data records are therefore recorded in advance in a first phase, preferably at different instants, so the target volume for irradiating is in different positions and/or states of deformation in the planning data records. The more planning data records are recorded, the sooner the bandwidth of the positions or deformations of the target volume, which are conventionally different, is detected. However, three to five planning data records are conventionally already likely to suffice for detecting a sufficient segment from the bandwidth of the most important changes in the position and shape of the target volume. The plurality of planning data records may include those in which the target volume for irradiating coincidentally has a substantially identical position or deformation. This is not damaging to the method as long as the majority of planning data records covers the bandwidth of the most important changes in the position and shape of the target volume overall.

An irradiation plan is subsequently created for each of these planning data records. The irradiation plans are optimized to the respective peculiarities which are given by the planning data records. Planning data records are conventionally recorded using a computed tomography (CT) scanner.

If, for example, a verification data record, which also represents the target volume, is recorded on a day on which irradiation is planned, a comparison may be made between the verification data record and the planning data records. The comparison serves to determine a similarity between the verification data record and each of the planning data records, for example, using a similarity measure which indicates the extent of correlation between the verification data record and one of the planning data records in each case.

The verification data record and the planning data records will conventionally represent the target volume and the surrounding organs/structures. However, it is also conceivable that represented in the verification data record are predominantly or only those volumes which have an effect on the position of the target volume, without representing the target volume itself.

The verification data record can also be recorded using a CT scanner. An imaging modality different from that used in the case of the planning data records may also be used, however, for example, a cone beam CT which can be recorded using a C-arm X-ray device.

It is even conceivable for the verification data record to only be a two-dimensional (2D) data record, for example a 2D X-ray image, which represents the target volume and is compared with the planning data records. Suitable digitally reconstructed radiographs (also called DDR) may be produced for the comparison in the case of CT planning data records. Alternatively, and/or in addition to, the CT planning data records, which are used for irradiation planning, 2D planning data records may also be recorded which match the 2D verification image and are used for the comparison.

Comparison of the planning data records with the verification data record with respect to similarity allows differences that exist between the verification data record and a planning data record to be determined and evaluated in each case.

Various known mathematical methods are available for determining a measure to assess similarity, such as a sum of squared differences, a cross correlation and mutual information. However, geometric distances in the data records, for example of prominent structures, may be determined and the similarity measure using the geometric distances may be calculated.

It is also conceivable to carry out a registration to determine the similarity between the verification data record and the planning data records. Registration indicates the transformation that is required to convert a planning data record into the verification data record. A measure can be determined from this transformation rule which indicates the similarity between the verification data record and one of the planning data records. However, depending on the type of registration used, this method can be computationally intensive compared with other methods of finding a measure for assessing similarity.

The planning data record which exhibits the greatest correlation or similarity with the verification data record is then selected. The irradiation plan associated with this planning data record is then the selected irradiation plan which can subsequently optionally be used to actually carry out the planned irradiation.

Using the method it is consequently possible to select an irradiation plan which is most suitable for the specific situation that exists at the instant at which the verification data record is recorded. This irradiation plan can then be used, for example, optionally, after checking additional circumstances, for a subsequent irradiation session. However it is not imperative to carry out an irradiation treatment. Other reasons, for example, such as a suddenly occurring indisposition of the patient or other unforeseen events, can lead to an irradiation treatment not being carried out as planned with the selected irradiation data record.

Overall the method improves adaptive irradiation planning and therewith the possibilities for adaptive radiotherapy which takes account of the anatomy that exists on a specific day. It is hereby possible to reduce the extent of a safety margin but still ensure that the target volume is covered with a desired dose.

The method has the advantage that no re-calculation, optimization or adjustment of an existing irradiation plan is necessary, for which laborious registration of image data records would possibly have to be carried out, for determining the irradiation plan to be used. Only a comparison between data records is carried out, and this leads directly to an existing irradiation plan which has conventionally already been checked and been deemed acceptable. Laborious calculations are omitted so the method can be carried out quickly and easily. Safety-critical aspects, which would otherwise exist, are smartly solved, moreover, as re-calculation of the irradiation plan or a modification of an existing irradiation plan always harbors the risk of the resultant irradiation plan no longer satisfying the safety-relevant requirements and of these aspects having to be ensured again.

If desired the verification data record and the planning data records can be aligned with each other before carrying out the comparison, ensuring that corresponding areas are also compared with each other during the comparison. An alignment of this kind could also be dispensed with, however, if the patient was sufficiently precisely positioned in the same position during recording of the planning data records and of the verification data record.

In an advantageous variant an area is selected in one of the planning data records and/or the verification data record, with the verification data record only being compared in this area with the plurality of planning data records with respect to similarity.

The area includes a portion of the representation of the planning data record and/or the verification data record. Certain areas, which are irrelevant, or even harmful to the comparison, with respect to similarity, can be excluded. These areas can include bony structures, for example, which conventionally do not differ, or do not differ greatly, in their position from one planning data record to the next. Bony structures can be used to determine an alignment between the planning data records and the verification data record, although bony structures are less relevant to the evaluation of the similarity of other internal anatomy.

Organs or sections of organs which are variable in terms of their shape and position, but which do not have any physical relation to the target volume as they are distant therefrom and do not have any point of contact therewith, can also be excluded during a comparison with respect to similarity. For example, the bladder and rectum, which are adjacent organs, are relevant to the situation, position and shape of the prostate. Sections of the colon that are situated further away have virtually no effect, however. If the comparison with respect to similarity is only carried out in a specific area, remote structures of this kind, which would have a tendency to distort rather than improve the result, can be excluded from the comparison. In this embodiment the area therefore does not include at least one portion in one of the planning data records and/or the verification data record, which portion has no point of contact with the target volume.

In one embodiment, the area includes the target volume and/or at least one area adjoining the target volume ad/or an entry channel of a treatment beam.

As the area can include an area adjoining the target volume the fact that structures and/or organs which adjoin the target volume often influence the position and/or the shape of the target volume is taken into account. Boundaries between structures may be used when determining similarity as these boundaries may exhibit characteristic differences in the planning and verification data records, while individual organs can sometimes present themselves homogeneously.

As the area can include the entry channel of a treatment beam, the requirements which primarily occur within the framework of particle therapy are taken into account. While the entry channel is less important in the case of irradiation with photons, as the condition of the entry channel has little influence on the dose deposited in the target volume, the conditions in the entry channel in the case of irradiation with particles are more important as variations in density that occur in this case have a sensitive effect on the range of the particle beam. As the entry channel is taken into account when evaluating the similarity between the verification data record and the planning data records, the choice of suitable irradiation plan can be decisively improved.

The area may only include an area which does not have a direct point of contact with the target volume. The verification data record could, by way of example, be a two-dimensional fluoroscopic image. In an image of this kind it is possible that the representation of the target volume, often soft tissue, is of a poor quality only. Other structures, such as bones or the diaphragm, can be depicted in a more defined manner in these images and can therefore be better identified. In the case of irradiation, for example of a lung tumor, it can then sometimes already be sufficient to take account of the position of the diaphragm and use it when comparing the verification data record with the planning data records, and not the target volume.

In one embodiment, the area may only partially include at least one structure that adjoins the target volume, for example, an organ that adjoins the target volume.

That an organ adjoining the target volume does not necessarily have to be assessed in full with respect to similarity was also recognized in this case. It is sometimes already sufficient to only take account of the area of the organ or structure that adjoins the target volume.

In one embodiment, the plurality of planning data records and/or the verification data record, and preferably all data records, include a time dimension. The time dimension may used to represent a movement characteristic in the plurality of planning data records and/or in the verification data record.

The planning data records can be four dimensional (4D) CT data records and the verification data record a 4D cone beam CT data record, for example. Data records of this kind allow a movement, which can occur during a planned irradiation session, to be evaluated. The movement characteristic, for example, which is present in the verification data record, may be compared with the different movement characteristics which are present in the planning data records. This may take place, for example, by determining a parameter, which characterizes the movement, such as an amplitude or a frequency of the movement, and optionally together with an additional parameter such as the center of the target volume or its central position.

Similarity can be evaluated jointly or separately between various phases of the movement for such a use. The planning data record which has the most similar characteristic with respect to movement can then be selected.

In one embodiment, a sensitivity map may be used when comparing the plurality of planning data records with the verification data record. The sensitivity map characterizes variability between the plurality of planning data records with respect to different regions. The sensitivity map may be determined by comparing the plurality of planning data records with each other and/or with the verification data record.

The sensitivity map, which can be determined from the data records, identifies the following: which areas have strong variability from one planning data record to the next and which areas tend to be more constant. The sensitivity map may be used when comparing the verification data record with the planning data records as it is accordingly known which areas have to be taken into particular account during the comparison. This consideration can be introduced by way of weighting facts for example. A sensitivity map may be determined by including the verification data record, by taking account of or incorporating the changes in the planning data records based on the verification data record, for example.

A sensitivity map can be created for example by calculating the mean value of the absolute HU differences (HU=Hounsfield Units) between the planning data records per voxel. The size of this mean value then characterizes the anticipated changes that occur between the various data records. Other parameters may also be used to create the sensitivity map, for example, known statistical parameters such as the minimum or maximum of the differences or the standard deviation, etc. can be used.

The sensitivity map can, for example, be used to create a new mask which characterizes the areas which are to be used for evaluating similarity. The sensitivity map can also be used to differently weight different regions within the area, with respect to which area similarity is being evaluated, in order for example to take greater account of sensitive areas. Sensitivity maps may also only be used for specific portions of the data records.

In one embodiment, the irradiation plans are created under identical specifications, in particular as far as the safety margins that are to be used are concerned. Accordingly, the same irradiation strategy is used when creating the irradiation plans. Only the different situation, i.e. the different position, and/or shape of the target volume is then taken into account when creating the irradiation plans. Further specifications, such as desired dose, structures to be treated with care, safety margins, etc. remain the same. The irradiation plans may, in principle, be compared with each other as a result. This simplifies the potential for automating the method as the irradiation strategy is not changed.

The device for selecting an irradiation data record is designed to carry out one of the above-described methods. The device comprises an input mechanism with which a verification data record and a plurality of planning data records can be loaded, a comparator with which the verification data record can be compared with the plurality of planning data records with respect to similarity, an evaluation mechanism with which a planning data record, which has the greatest similarity to the verification data record, can be determined from the plurality of planning data records, and a selector with which an irradiation plan, which is associated with the planning data record determined by the evaluation mechanism, can be loaded.

The individual sub-units of the device can be implemented in a single computer unit which is constructed in such a way that the computer unit can execute the function of the individual sub-units.

The computer unit may, for example, be a control unit of an irradiation facility, for example a particle therapy facility, which, for example is connected to an irradiation planning device that is constructed for creating the irradiation plans for the planning data records.

It may also be provided that an area in one of the planning data records and/or in the verification data record may be determined such that the verification data record is only compared in the determined area with the plurality of planning data records with respect to similarity.

The comparator can also be constructed in such a way that when the plurality of planning data records is compared with the verification data record, a sensitivity map is used which characterizes variability between the plurality of planning data records with respect to different regions.

The sensitivity map can be determined by way of example if the planning data records are compared with each other and/or with the verification data record.

An irradiation facility according to the invention, in particular a particle therapy facility, comprises a device of this kind.

### BRIEF DESCRIPTION OF THE DRAWINGS

FIG. 1 shows a schematic overview of one embodiment of a particle therapy facility,

FIG. 2 shows a schematic diagram of an embodiment of a device,

FIG. 3 shows a diagram which illustrates the comparison of one embodiment of a verification data record with a plurality of planning data records,

FIG. 4 shows a diagram which illustrates the comparison of a verification data record with a plurality of planning data records, the data records including a time dimension,

FIG. 5 shows various areas of a data record in which an evaluation of similarity is carried out,

FIG. 6 shows a schematic view of one embodiment of a sensitivity map,

FIG. 7 shows one embodiment of a graph which shows the correlation between the similarity measure and the quality of the selected irradiation plan.

### DETAILED DESCRIPTION

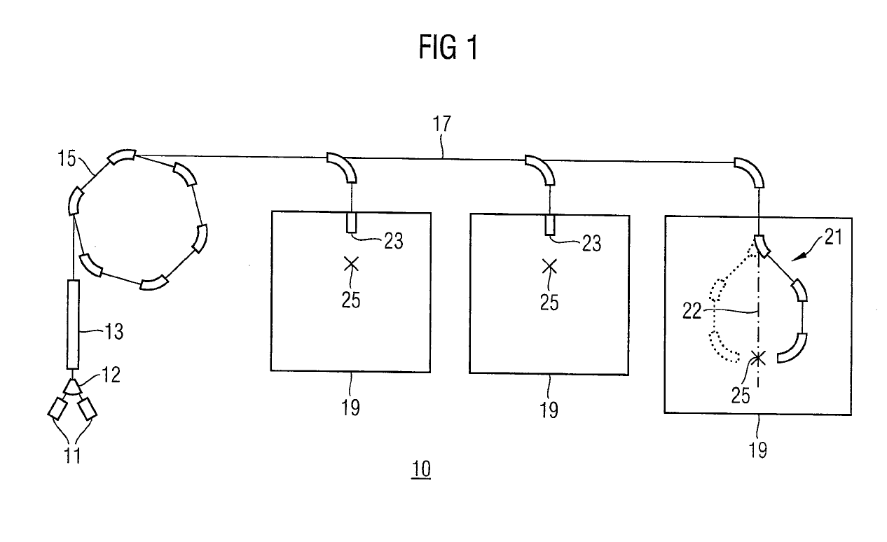

FIG. 1 shows a schematic overview of the construction of a particle therapy facility (system) 10. Irradiation of a body, especially tissue diseased by a tumor, or a phantom, with a particle beam takes place in a particle therapy facility 10.

Ions, such as protons, helium ions, carbon ions or other particles, such as pions, are primarily used as the particles. Such particles are conventionally produced in a particle source 11. If, as shown in FIG. 1, there are two particle sources 11, which produce two different types of ion, a switch can be made between these two types of ion within a short interval. A switching magnet 12, for example, is used for this purpose and is arranged between the ion sources 11 on the one hand and a pre-accelerator 13 on the other hand. The particle therapy facility 10 can for example be operated with protons and carbon ions simultaneously hereby.

The ions produced by the, or one of the, ion source(s) 11 and optionally selected using the switching magnet 12 are accelerated to a first energy level in the pre-accelerator 13. The pre-accelerator 13 is for example a linear accelerator (LINAC for “LINear ACcelerator”). The particles are then fed into an accelerator 15, for example, a synchrotron or cyclotron. The particles are accelerated in the accelerator 15 to high energy levels, as are required for irradiation. Once the particles have left the accelerator 15 a high-energy beam transport system 17 guides the particle beam to one or more irradiation chamber(s) 19. In an irradiation chamber 19 the accelerated particles are directed onto a body which is for irradiating. This takes place from a fixed direction (in what are referred to as “fixed beam” chambers) or from various directions via a moving gantry 21 that can be rotated about an axis 22, depending on the construction.

In the irradiation chamber 19, the particle beam exits a beam outlet 23 and strikes a target volume for irradiating, which is conventionally located in the isocenter 25 of an irradiation chamber.

The basic construction of a particle therapy facility 10, illustrated with reference to FIG. 1, is exemplary for particle therapy facilities but can also deviate from this.

The exemplary embodiments described hereinafter can be used in conjunction with the particle therapy facility 10 illustrated with reference to FIG. 1 as well as with other irradiation facilities in which an irradiation plan is to be selected.

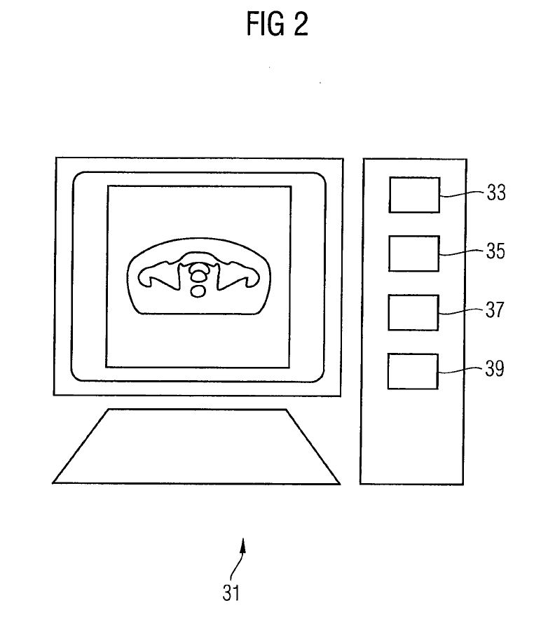

FIG. 2 shows a device 31 which is constructed for selecting an irradiation plan.

The device 31 may, for example, be implemented in a computer unit which is used for irradiation planning or execution of irradiation.

The device 31 comprises an input mechanism 33 with which a verification data record and a plurality of planning data records created in advance may be loaded. Data records may be stored in a database, so the input mechanism 33 includes interfaces via which the data records can be incorporated in the device 31.

The device 31 also includes a comparator 35 with which a similarity measure can be selected or loaded, and a comparison of the verification data record with the plurality of planning data records with respect to similarity can be made.

The device 31 includes an evaluation mechanism 37 with which a planning data record, which has the greatest similarity to the verification data record, is determined from the plurality of planning data records.

The device 31 includes a selector 39 with which an irradiation plan, which is associated with the planning data record determined by the evaluation mechanism, can be loaded. This irradiation plan can be transmitted to the irradiation facility 10, so irradiation is carried out in accordance with the irradiation plan.

The individual sub-units 33, 35, 37, 39 described may be implanted in a single computer unit, with the computer unit being constructed by suitable software and/or hardware in such a way that the functionalities of the individual sub-units are carried out.

The device 31 is constructed in such a way that the exemplary embodiments described with reference to the following figures can be carried out with it.

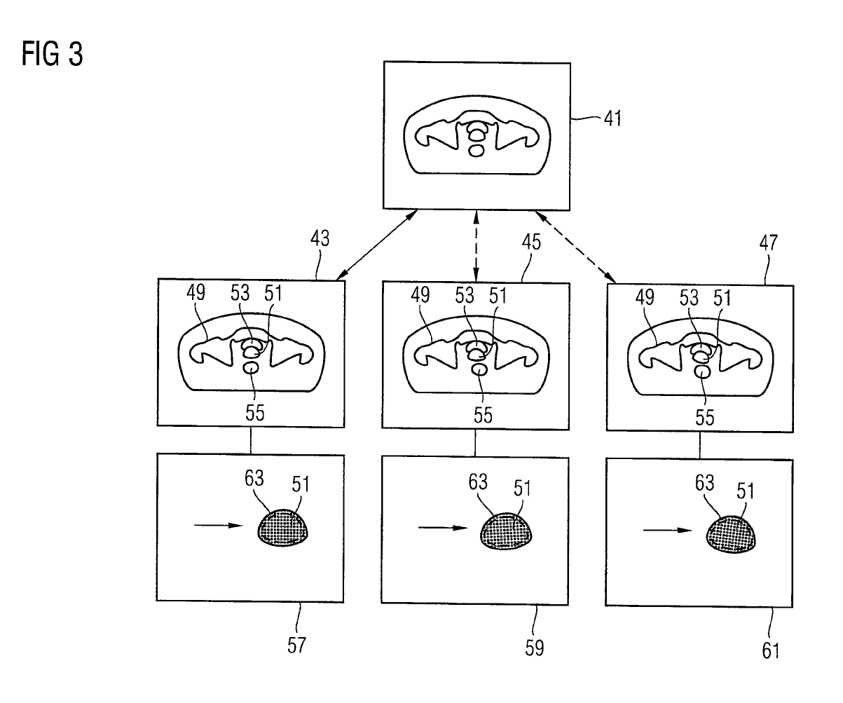

FIG. 3 schematically shows the comparison of a verification data record 41 with a plurality of planning data records 43, 45, 47.

A plurality of planning data records 43, 45, 47 may have been recorded in advance, for example, using CT equipment. A transversal section through the pelvis is symbolically illustrated in planning data records 43, 45, 47. A bony structure 49, which always has the same shape and position in the three planning data records 43, 45, 47, may be seen in the transversal section. The target volume for irradiating is the prostate 51, which is flanked by the bladder 53 and the rectum 55. Owing to the different levels of fullness of the bladder 53 and the different position and shape of the rectum 55 the prostate 51 has a slightly different position and shape in the three planning data records 43, 45, 47, which have been recorded at different instants. An irradiation plan 57, 59, 61 was created in advance for each of these three planning data records 43, 45, 47 by establishing how the target volume, i.e. the prostate 51, should be irradiated.

The clinical target volume around the prostate 51 was expanded by a safety margin 63 of the same size in the three irradiation plans 57, 59, 61, respectively. A large number of scanning elements which are to be successively scanned with a particle beam was established on this basis. The arrow in the irradiation plans 57, 59, 61 identifies one of the beaming directions of the particle beam.

A verification data record 41 may be recorded in advance of a planned radiation.

To select a suitable irradiation plan from irradiation plans 57, 59, 61 a comparison of the verification data record 41 with the three planning data records 43, 45, 47 is made. The comparison is geared toward a similarity between the verification data record 41 and the planning data records 43, 45, 47. In this illustrated case the left-hand planning data record 43 has the greatest similarity to the verification data record 41 with respect to position and shape of the prostate 51 and the organs 53, 55 surrounding the prostate.

The irradiation plan 57 that forms the basis of this planning data record 43 can then be used as the basis for irradiation—if subsequent irradiation takes place.

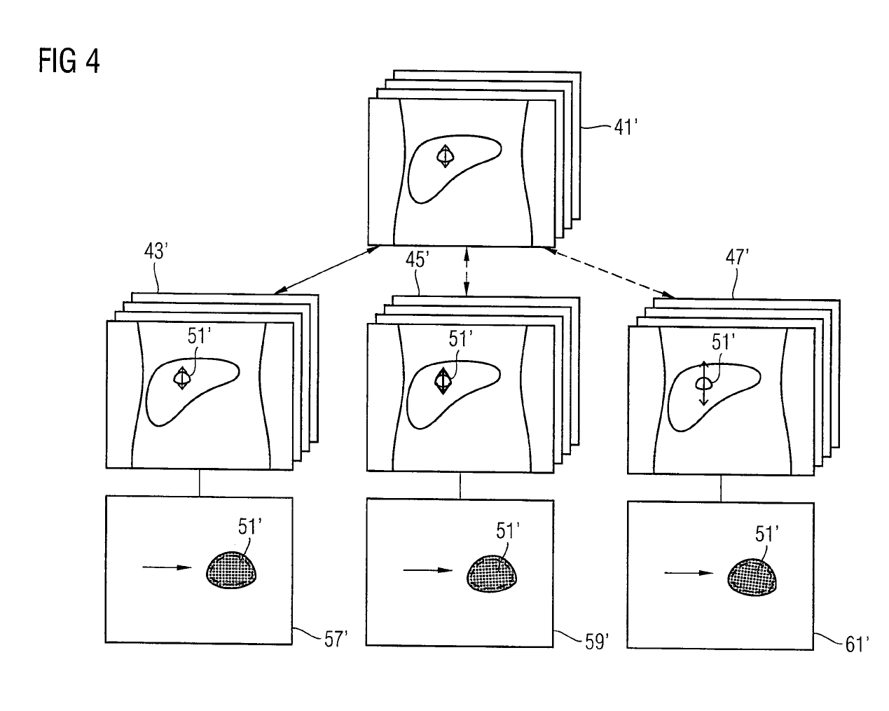

FIG. 4 illustrates a similar method, this time only for a target volume 51′ which moves a lot during an irradiation session such that the movement has to be taken into account when planning irradiation. Such a case may occur for example with tumors which are moved as a result of respiratory movement, such as in the case of liver metastasis 51′ for example.

The movement may be detected if the planning data records 43′, 45′ 47′ and/or the verification data record 41′ include a time dimension. The movement of the object can be determined from one of the planning data records 43′, 45′ 47′ or the verification data record 41′. A 4D CT, example, can be recorded as the planning data record and verification data record.

Three four-dimensional planning data records 43′, 45′, 47′ are shown. The different movements of the target volume 51′, for example the amplitude and frequency of the movement, are symbolized in the diagram by arrows of different lengths and different thickness.

A four-dimensional verification data record 41′ may be compared with the three four-dimensional planning data records 43′, 45′, 47′, and planning data record 43′ is identified as having the greatest similarity to verification data record 41′. The movement of the target volume 51′ is also taken into account this time during the comparison. The other comparison features, such as the position and shape of the target volume, the entry channel, the surrounding structures, etc., can continue to be taken into account.

To compare the movement, the center of the target volume 51′, the average position of the target volume 51′ and movement parameters, such as the amplitude and frequency, may, for example, be compared with each other.

From irradiation plans 57′, 59′, 61′, irradiation plan 57′ is then selected, which forms the basis of planning data record 43′ and has the greatest similarity to verification data record 41′.

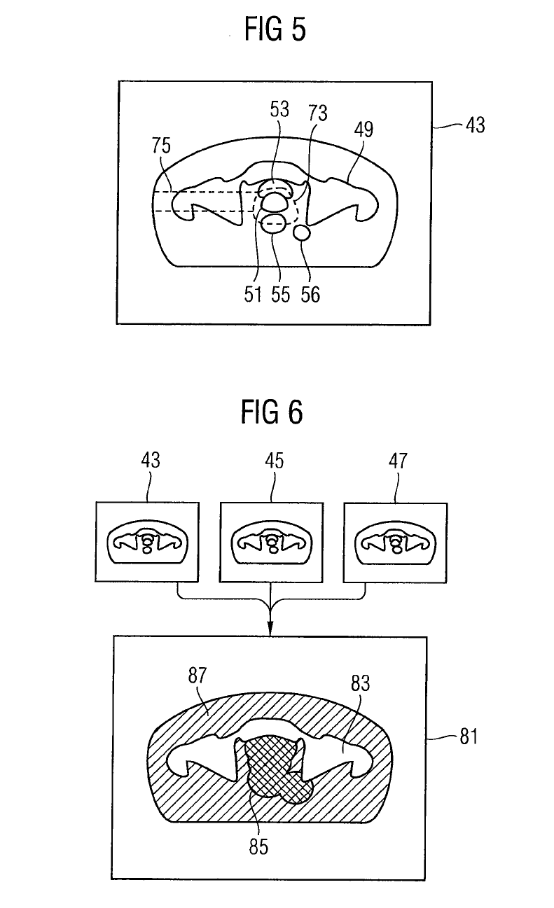

FIG. 5 shows a planning data record 43 in which certain regions are marked. The marked regions indicate which areas of the planning data record or verification data record are evaluated with respect to similarity.

A first region 73 includes the target volume, for example, the prostate 51. The first region 73 may include the structures or organs that adjoin the target volume, such as the bladder 53 and rectum 55, although only partially. The first region 73 adjoins the area, with respect to which the similarity is evaluated, in such a way that areas that are located further away do not enter into the evaluation of similarity even if they exhibit high variability with respect to position and shape. In the illustrated example, a section 56 of the intestine is located further away but which has only a very slight, if any, effect on the position and shape of the prostate 51. The surrounding bony structure 49 should be excluded from the first area 73.

If irradiation planning takes place with particle beams, an additional area 75, which is at least partially located in the entry channel of the particle beam, may be evaluated with respect to similarity. The particle beam also has a suitable range as the range of the particle beam is predominantly influenced by structures that are located in front of the target volume in the beam direction.

An algorithm will be described hereinafter, which has proven to be expedient in the case of irradiation plans relating to the prostate 51, in order to select an area with respect to which the planning data records are compared with the verification data record, hereinafter called the comparison area.

In the algorithm the target volume (CTV for “clinical target volume”) is determined The target volume may be the prostate 51. A cuboid of a specific size is placed around each voxel, which is associated with the prostate 51, for example, a cuboid comprising 5×5×3 voxels. Each of these cuboids is analyzed for whether there is at least one voxel in the cuboid which is associated either with the bladder 53 or the rectum 55, i.e. the surrounding organs.

Each of these cuboids is also analyzed for whether there is a voxel in the cuboid which is associated with a bony structure 49, such as the hip bone, i.e. a structure which should be excluded from the area which forms the basis of evaluation of similarity.

If one of the cuboids includes a voxel which is associated with the bladder 53 or the rectum 55 the comparison area around this cuboid is expanded, unless the cuboid at the same time includes a voxel which is associated with a bony structure 49.

A decision as to whether the latter case exists can be made in the case of a CT data record using Hounsfield Units (HU). Cuboids which include a voxel of the bladder 53 as well as a voxel above 600 HU fall into this category, as do cuboids which include a voxel of the rectum 55 as well as a voxel above 1,200 HU. The threshold values may be established as at 600 HU and 1,200 HU. These values are arbitrary but have proven advantageous when evaluating CT data records which represent the prostate 51. The threshold values can also be changed and adapted to the circumstances that exist in each case.

The comparison area may include all cuboids, which have been determined as described above, as well the target volume, in this case the prostate 51.

The algorithm just described has the advantage that it can largely be easily automatically implemented, so interaction with a user is necessary to only a very small extent, if at all.

FIG. 6 schematically shows the creation of a sensitivity map 81 which may advantageously be used when selecting the areas which are evaluated with respect to similarity. The sensitivity map 81 is produced from the comparison of a plurality of planning data records 43, 45, 47. The sensitivity map 81 indicates how great the variability of individual areas is between the various planning data records 43, 45, 47, and preferably how great the changes per voxel are from one planning data record to the next. In one embodiment, the changes between verification data record and planning data records may also be taken into account to create the sensitivity map 81.

The sensitivity map 81 illustrated may include three discrete areas 83, 85, 87. Sensitivity with respect to variability between the planning data records can also be determined voxel-wise however.

The sensitivity map 81 indicates very low variability here in an area 83 of bony structures. An area 85 around the prostate or the bladder and around the intestine has the highest variability. A different area 87, such as surrounding fat or muscle tissue for example, has medium variability.

The sensitivity map 81 may be used, for example, to weight specific areas differently when making the comparison between verification data record and planning data records, depending on how great the anticipated changes in the respective areas are.

An algorithm will be described hereinafter as creates a sensitivity map 81 and may advantageously be used when comparing data records in which the prostate is represented.

In a first act, differential data records are created between the verification data record 41 and the various planning data records 43, 45, 47 by subtracting voxel-wise one planning data record respectively from the verification data record.

The mean value and the standard deviation are then determined from the differential data records produced and a mean value sensitivity map or a standard deviation sensitivity map thus produced. From these statistical values it may be inferred how greatly the planning data records 43, 45, 47 vary among each other with respect to the individual voxels.

The determined mean value sensitivity map and the determined standard deviation sensitivity map can then be subjected to a threshold value observation. To identify the voxels which have a great variation between CT data records a lower threshold value is introduced from the standard deviation sensitivity map. A value of 20 HU may be used as the lower threshold value. To refer to changes which are caused by changes in soft tissue and not by rectal accumulations of gas, an upper threshold value was introduced for the mean value sensitivity map. A value of 50 HU has proven to be advantageous as the upper threshold value.

The comparison range, as has been described further above, may be refined such that the improved comparison range includes only those voxels which lie above the lower threshold value of the standard deviation sensitivity map and below the upper threshold value of the mean value sensitivity map.

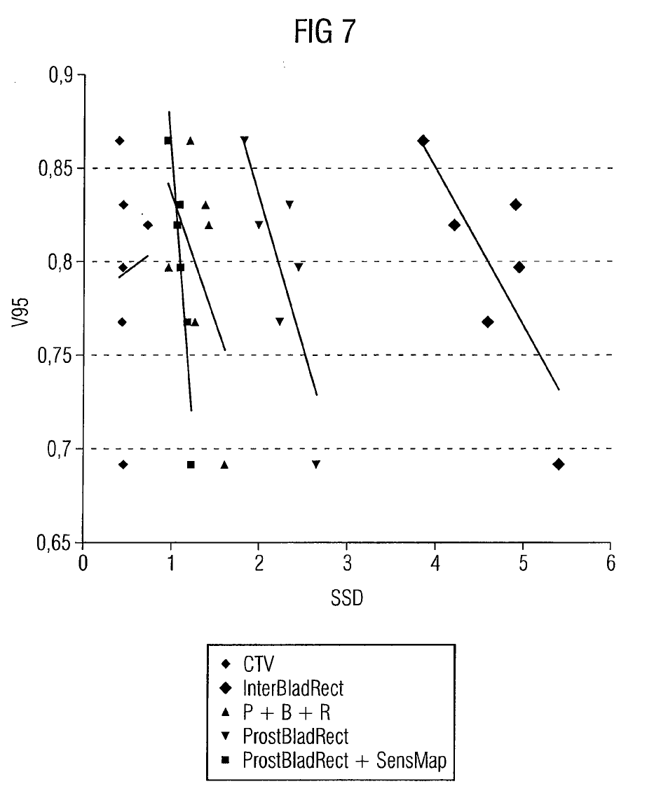

FIG. 7 shows the correlation between the sum of squared differences in the comparison range and the dose allocation of the target volume and, more precisely, for various types of comparison ranges.

The sum of squared differences (SSD=“sum of squared differences”) are calculated for a comparison range using the following formula:

$$SSD = {\sum }_{m} {( {D}_{m} - {P}_{m} )}^{2} / NV ,$$

where m denotes the index of the voxels of the comparison range, Dₘ and Pₘ the values of a voxel m in the verification data record or planning data record, and NV the number of all voxels in the comparison range.

The SSD consequently indicates how great the difference between a verification data record 41 and a planning data record 43, 45, 47 is in the comparison range, and is therefore a measure of the similarity between a planning data record 43, 45, 47 and the verification data record 41.

The V95 value, an index which indicates how well the target volume is covered by a dose (target coverage), opposes the SSD (i.e. the value of the x axis). The V95 value is a value that is common in radiotherapy and indicates which portion of the target volume is covered by at least 95% of the desired dose if a specific irradiation plan is used.

There is a correlation between the SSD and the V95 value. The correlation depends on which comparison range was used as the basis when determining the SSD.

If a comparison range, as is described further above, prostate 51 with adjoining structures such as the adjoining part of the bladder 53 and the adjoining part of the rectum 55, improved with the aid of the sensitivity map 81, designated “ProstBladRect+SensMap” in the graph—is taken as the basis when determining the SSD, there is a good correlation between SSD and the V95 value.

A suitable irradiation plan 57, 59, 61 may be selected by merely comparing the verification data record 41 with various planning data records 43, 45, 47 with respect to similarity. For the irradiation planning of the prostate Slit has been found that the best correlation results if this comparison range forms the basis of the comparison of planning data record 43, 45, 47 with verification data record 41 and the similarity measure is determined via an SSD.

Similarly good correlations, although with slightly poorer correlation, result if the following are used as the basis of the comparison ranges:—the prostate 51 with the adjoining part of the bladder 53 and rectum 55, but this time without improvement by way of a sensitivity map; designated “ProstBladRect” in the graph,—the prostate 51 and the entire bladder 53 and entire rectum 55; designated “P+B+R” in the graph,—only the intersecting points prostate/bladder and prostate/rectum; designated “InterBladRect” in the graph.

The reduced quality correlation results if only the prostate 51 is used as the basis of the comparison range; designated “CTV” in the graph.

A further possibility for determining the similarity measure is a correlation coefficient which the following formula calculates:

$$CC = \frac{{\sum }_{m} ( {D}_{m} - \overline{D} ) ( {P}_{m} - \overline{P} )}{\sqrt{( {\sum }_{m} {( {D}_{m} - \overline{D} )}^{2} ) ( {\sum }_{m} {( {P}_{m} - \overline{P} )}^{2} )}}$$

where m is the index of the voxels of the comparison range, Dₘ and Pₘ the values of a voxel m in the verification data record or in the planning data record, and D̅ and P̅ are the mean values of the voxels in the comparison range.

The irradiation planning of the prostate 51 has found that the correlation coefficient delivers poorer results than the SSD. This may be different for other irradiation scenarios however, for example, other tumors or organs.

Using the correlation curves illustrated in FIG. 5 a comparison range may be easily tested, or an instruction according to which a similarity measure is determined between the verification data record and one of the planning data records, are suitable for selecting an irradiation plan.

For this purpose only the correlation between the similarity measure and the V95 are tested. As soon as it emerges that the correlation is good enough, the similarity measure and/or the comparison range can be used in the method for determining the irradiation plan 57, 59, 61.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for selecting an irradiation plan, comprising:
in a first phase, detecting a plurality of planning data records in which a target volume for irradiating and with varying position is represented in a target object, and creating an irradiation plan for each of these planning data records; and
in a second phase, which follows the first phase, recording a verification data record, comparing the verification data record with the plurality of planning data records with respect to similarity, selecting a planning data record from the plurality of planning data records which has the greatest similarity to the verification data record, and selecting an irradiation plan which is associated with the selected planning data record.

2. The method as claimed in claim 1, wherein an area in one of the planning data records and/or in the verification data record is selected and the verification data record is only compared in this area with the plurality of planning data records with respect to similarity.

3. The method as claimed in claim 2, wherein the area includes the target volume and/or at least one area adjoining the target volume and/or an entry channel of a treatment beam.

4. The method as claimed in claim 3, wherein the area does not include at least one portion in one of the planning data records and/or the verification data record, which portion does not have a point of contact with the target volume.

5. The method as claimed in claim 4, wherein the area only partially includes at least one structure adjoining the target volume.

6. The method as claimed in claim 1, wherein the plurality of planning data records and/or the verification data record include a time dimension.

7. The method as claimed in claim 1, wherein comparing the plurality of planning data records includes using a sensitivity map, the sensitivity map characterizing a variability between the plurality of planning data records with respect to different regions.

8. The method as claimed in claim 1, wherein the irradiation plans for the planning data records are created under identical specifications with respect to the safety margins to be used.

9. A device for selecting an irradiation plan, comprising:
an input mechanism with which a verification data record and a plurality of planning data records can be loaded,
a comparator with which the verification data record can be compared with the plurality of planning data records with respect to a similarity,
an evaluation mechanism with which a planning data record, which has the greatest similarity to the verification data record, can be determined from the plurality of planning data records, and
a selector with which an irradiation plan, which is associated with the planning data record determined by the evaluation mechanism, is loaded.

10. The device as claimed in claim 9, wherein the comparator is operable to determine an area in one of the planning data records and/or in the verification data record, wherein the verification data record is only compared in the area with the plurality of planning data records with respect to similarity.

11. The device as claimed in claim 10, wherein when comparing the plurality of planning data records with the verification data record, the comparator is operative to use a sensitivity map which characterizes a variability between the plurality of planning data records with respect to different regions.

12. The device as claimed in claim 11, wherein an irradiation planning device is also provided with which a respective irradiation plan can be created for the planning data records.

13. An irradiation system comprising:
a device for selecting an irradiation plan, comprising:
an input mechanism with which a verification data record and a plurality of planning data records can be loaded,
a comparator with which the verification data record can be compared with the plurality of planning data records with respect to a similarity,
an evaluation mechanism with which a planning data record, which has the greatest similarity to the verification data record, can be determined from the plurality of planning data records, and
a selector with which an irradiation plan, which is associated with the planning data record determined by the evaluation mechanism, is loaded.
